(19) United States
(12) Patent Application Publication
(10) Pub. No.: US 2004/0114206 A1
(43) Pub. Date: Jun. 17, 2004

(54) Current driver for an analog micromirror device

(76) Inventor: Narayana Sateesh Pillai, Plano, TX (US)

Correspondence Address: TEXAS INSTRUMENTS INCORPORATED, P O BOX 655474, M/S 3999, DALLAS, TX, 75265

(21) Appl. No.: 10/318,684

(22) Filed: Dec. 13, 2002

(51) Int. Cl. G02B 26/08

(52) U.S. Cl. 359/223

(57) ABSTRACT

A drive system for a analog micromirror device includes an operational amplifier having a noninverting input coupled to a voltage control signal and an inverting input coupled to the output via the actuating coils of the micromirror device. A resistor is coupled between the inverting input and a reference potential.

### REFERENCE TO RELATED APPLICATIONS

This application is related to U.S. patent application Ser. No. ______ (TI-34742) entitled “Automatic Test System for Micromirror Device”, commonly assigned and filed on even date herewith, which is incorporated herein by reference.

### FIELD OF THE INVENTION

This application relates to a current driver for a micromirror device, and more particularly to a current driver utilized in an automatic test system for a micromirror device.

### BACKGROUND OF THE INVENTION

Modern data communications technologies have greatly expanded the ability to communicate large amounts of data over many types of communications facilities. This explosion in communications capability not only permits the communications of large databases, but has also enabled the digital communications of audio and video content. This high bandwidth communication is now carried out over a variety of facilities, including telephone lines (fiber optic as well as twisted-pair), coaxial cable such as supported by cable television service providers, dedicated network cabling within an office or home location, satellite links, and wireless telephony.

A relatively new technology that has been proposed for data communications is the optical wireless network. According to this approach, data is transmitted by way of modulation of a light beam, in much the same manner as in the case of fiber optic telephone communications. A photoreceiver receives the modulated light, and demodulates the signal to retrieve the data. As opposed to fiber optic-based optical communications, however, this approach does not use a physical cable for transmission of the light signal. In the case of directed optical communications, a line-of-sight relationship between the transmitter and the receiver permits a modulated light beam, such as that produced by a laser, to travel without the waveguide of the fiber optic cable.

Apparatus useful for such communications links is known from U.S. Pat. No. 6,295,154, entitled “Optical Switching Apparatus”, commonly assigned herewith and incorporated herein by reference. This patent discloses a micromirror assembly for directing a light beam in an optical switching apparatus. As disclosed in this patent, which reflects the light beam in a manner that may be precisely controlled by electrical signals, the micromirror assembly includes a silicon mirror capable of rotating in two axes. One or more small magnets are attached to the micromirror itself; a set of four coil drivers are arranged in quadrants, and are controlled to attract or repel the micromirror magnets as desired, to tilt the micromirror in the desired direction.

Co pending application Ser. No. 90/957,476 which is commonly owned and which is incorporated herein by reference provides a micromirror assembly that includes a package and method for making a package having a sensing capability for the position of the micromirror. This package and method is relatively low-cost, and well suited for high-volume production. The package is molded around a plurality of coil drivers, and their control wiring, for example by injection or transfer molding. A two-axis micromirror and magnet assembly is attached to a shelf overlying the coil drivers. Underlying the mirror is a sensor for sensing the angular position of the mirror. According to the preferred embodiment of the invention, the sensor includes a light-emitting diode and angularly spaced light sensors that can sense the intensity of light emitted by the diode and reflecting from the backside of the mirror. The position of the mirror can be derived from a comparison of the intensities sensed by the various angularly positioned light sensors.

These devices have been driven from voltage signals in the prior art. The problem with utilizing voltage signals for driving a micromirror device is that the current through the coils determines the magnetic force generated and therefore the deflection of the mirror. If a voltage drive signal is utilized, variations in the resistance and inductance of the coils change the amount of current therethrough and thus the amount of magnetic force that is generated. Thus, reliance is made on the feedback arrangement from the position sensing apparatus to properly position the mirror.

This is particularly a problem when the mirror is placed in an automated testing apparatus, such as in U.S. application Ser. No. ______ entitled “Automatic Test System for a Micromirror Device” (TI-34742) which is filed on even date herewith, commonly owned and incorporated here by reference, where linear tracking from a generated voltage signal is important as is strict control over the maximum current in order to prevent damage to the device under test.

### SUMMARY OF THE INVENTION

It is a general object of the invention to provide a current driver for a micromirror device.

This and other objects and features are attained, in accordance with an aspect of the invention comprising a drive system for a micromirror device including an operational amplifier having inverting and noninverting inputs, the noninverting input coupled to a voltage control signal. A resistor is coupled between the inverting input and a reference potential. Actuating coils for the micromirror device are coupled between an output of the operational amplifier and the inverting input, whereby current flowing through the actuating coils is determined by the voltage control signal and the resistor.

Another aspect of the invention includes a method for driving actuator coils of a micromirror device. A voltage control signal is provided to a driver for the micromirror device. A current signal is generated in the driver which is directly proportional to the voltage control signal. The driving the actuator coils of the micromirror device are driven with the current signal.

A further aspect of the invention is provided by a tester for a micromirror device including a computer for controlling testing of the micromirror device according to a test program. A digital to analog converter generates control signals and an interface receives signals indicative of performance of the micromirror device. A driver actuates the micromirror device. An operational amplifier has magnetic coils of the micromirror device connected in a feedback loop from an output of the operational amplifier to an inverting input thereto. A resistor is coupled between the inverting input and a reference potential.

### BRIEF DESCRIPTION OF THE DRAWINGS

FIG. 1 is a schematic drawing of a current driver for a miromirror device according to the present invention;

FIG. 2 is a block diagram of a tester for a micromirror device described in co pending application Ser. No. (TI-34742) commonly assigned and filed on even date herewith, incorporating the present invention.

### DETAILED DESCRIPTION OF THE PRESENT INVENTION

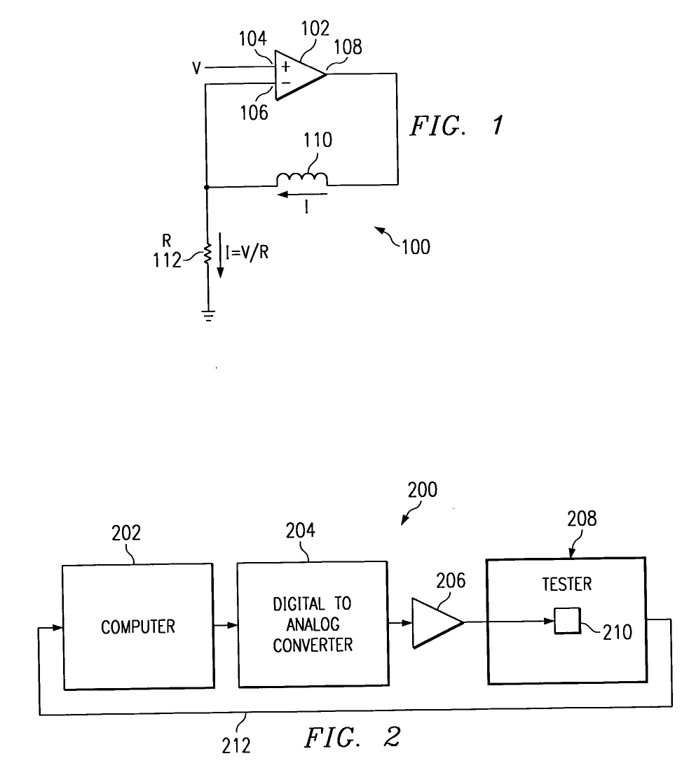

FIG. 1 is a schematic drawing of a current driver, generally shown as 100, according to the present invention. The current driver includes a high current operational amplifier 102 having a noninverting input 104 coupled to a voltage drive signal. An output 108 is connected via the magnetic coil of the micromirror device 110 to the inverting input 106 of the operational amplifier 102. The inverting input 106 is also connected to a resistor 112, which has its other terminal connected to ground. The coil 110 can be placed in the feedback path since both terminals of the coil are floating, that is not connected to either the voltage supply or the reference potential.

The negative feedback used means that the inverting terminal will have the same voltage as the applied voltage V. Therefore, the voltage across resistor 112 will be the same as the input voltage. The current through the resistor determined by Ohms law will be the input voltage divided by the resistance which must be produced by the output of the operational amplifier 102. Placing the coil 110 in the feedback means that the current produced by the operational amplifier will also flow through the coil 110. Thus, the current flowing through coil 110 is determined only by the value of the resistor and external applied voltage V.

Utilizing this drive circuit, the magnetic force produced in the coil is directly proportional to the input voltage V and is unrelated to the resistance or inductance of the coil 110. This provides a linear drive signal, which places lesser constraints on the utilization of feedback from the internal position sensing device, which makes the circuitry needed to drive the mirror simpler. Furthermore, it eliminates the effects of variations in the resistance and inductance of the coil which is important in automatic testing of the micromirror devices, as shown in FIG. 2.

FIG. 2 shows a basic setup of a computerized automatic testing system for a micromirror device as shown in U.S. application Ser. No. ______ “Automatic Test System for a Micromirror Device” (TI-34742), incorporated herein by reference, generally as 200. The system comprises a computer 202 which runs a test program to generate digital signals and an output of the computer which is coupled to a digital to analog converter 204. The digital to analog converter converts the digital signals into an analog voltage which is applied to the input of the driver device 206 as shown in FIG. 1. The output of a driver device is coupled to a coil, such as coil 110, on the device under test (DUT) 210. The device under test is mounted on the top of a tester 208 so that it may readily be removed. The tester 208 tests various parameters of the DUT and provides measurement signals along lines 212 which are fed back to the computer 202 to evaluate the performance of the DUT.

While the invention has been shown and described with reference to preferred embodiments thereof, it is well understood by those skilled in the art that various changes and modifications can be made in the invention without departing from the spirit and scope of the invention as defined by the appended claims.

1. A drive system for a micromirror device comprising:
an operational amplifier having inverting and noninverting inputs, the noninverting input coupled to a voltage control signal;
a resistor coupled between the inverting input and a reference potential;
actuating coils for the micromirror device coupled between an output of the operational amplifier and the inverting input, whereby current flowing through the actuating coils is determined by the voltage control signal and the resistor.

2. The drive system of claim 1 wherein the operational amplifier is a high current operational amplifier.

3. A method for driving actuator coils of a micromirror device comprising:
providing a voltage control signal to a driver for the micromirror device;
generating a current signal in the driver which is directly proportional to the voltage control signal; and
driving the actuator coils of the micromirror device with the current signal.

4. The method of claim 3 further comprising:
generating the voltage control signal in a digital to analog converter of computerized micromirror tester in accordance with a test program.

5. The method of claim 3 wherein generating the current signal comprises inputting the voltage control signal to the noninverting input of an operational amplifier;
generating the current signal as a feedback signal from an output of the operational amplifier to an inverting input thereto.

6. The method of claim 4 wherein generating the current signal comprises inputting the voltage control signal to the noninverting input of an operational amplifier;
generating the current signal as a feedback signal from an output of the operational amplifier to an inverting input thereto.

7. In a tester for a micromirror device including a computer for controlling testing of the micromirror device according to a test program, a digital to analog converter for generating control signals and an interface for receiving signals indicative of performance of the micromirror device, a driver for actuating the micromirror device comprising;
an operational amplifier having magnetic coils of the micromirror device connected in a feedback loop from an output of the operational amplifier to an inverting input thereto; and
a resistor coupled between the inverting input and a reference potential.
